(19) United States
(12) Patent Application Publication
(10) Pub. No.: US 2016/0300321 A1
(43) Pub. Date: Oct. 13, 2016

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: Yuji Naya, Kashiwa-shi (JP)

(21) Appl. No.: 15/091,115

(22) Filed: Apr. 5, 2016

(30) Foreign Application Priority Data
Apr. 7, 2015 (JP) 2015-078384

(51) Int. Cl. G06T 3/00; G06K 9/00

(52) U.S. Cl. CPC G06T 3/00; G06K 9/00422

(57) ABSTRACT

There is provided an information processing apparatus comprising: a display unit configured to display an image including a plurality of objects on a screen; a generation unit configured to generate block information indicating information of blocks obtained by dividing the object for each attribute; an input unit configured to recognize handwriting of an annotation written on the image by hand; a detection unit configured to detect classification of the annotation based on the handwriting; and a display changing unit configured to estimate a partial region to focus based on a relation between the block information and the handwriting and dynamically change and display an expression of the partial region according to the classification of the annotation.

### BACKGROUND OF THE INVENTION

1. Field of the Invention

The present invention relates to an information processing apparatus, a method for controlling the information processing apparatus, and a storage medium.

2. Description of the Related Art

In recent years, opportunities to browse image data obtained by digitizing documents using image display apparatuses (for example, smartphones or tablet PCs) have increased. Further, opportunities to project image data being browsed using image display apparatuses by projectors onto screens (or display image data on large displays) for a plurality of people to browse the image data together have increased. Japanese Patent Laid-Open No. 2010-61623 discloses a method for recognizing objects included in image data, and then individually displaying the image data in an expansion manner according to the sizes of the objects when the image data of a document is displayed. Accordingly, content of the objects included in the digitized document can be automatically expanded to be easily viewed without necessity of a manual magnification manipulation or the like, so that a user can browse the content of the objects.

Japanese Patent Laid-Open No. 2010-205290 discloses a method for displaying document data on a screen and dynamically changing the position of handwritten information with a change in deletion or movement of the document data in an apparatus capable of writing the written information (electronic ink) using a digitizer such as a stylus. Accordingly, even when the document data is changed, the position of the handwritten information is not deviated. Therefore, the document data can be efficiently changed. Further, Japanese Patent Laid-Open No. 2004-110825 discloses a technology for determining the value of each annotation input in a handwritten manner to document data and adding and displaying an icon or the like to a reduced image of a page on which the annotation with a high value is written when the reduced image of each page of the document data is displayed. In the following description, handwritten information (electronic ink or digital ink) is referred to as a handwritten annotation.

However, in Japanese Patent Laid-Open No. 2010-61623, it is not assumed that a user inputs a handwritten annotation to image data and a method for dynamically changing display of an image based on the handwritten annotation to display the image is not mentioned. In Japanese Patent Laid-Open No. 2010-205290, an intention of an expositor may not be understood from the handwritten annotation added on an image during display of the image and an expression of a partial region of the image may not be dynamically changed and displayed in accordance with an expression of the intention. In Japanese Patent Laid-Open No. 2004-110825, an annotation input in a handwritten manner can be emphasized and displayed when an image is reduced and displayed, but an expression of a partial region of an image may not be dynamically changed and displayed during display of the image.

### SUMMARY OF THE INVENTION

The present invention provides an information processing apparatus that dynamically changes display of an image based on a handwritten annotation to display the image when a user inputs the handwritten annotation to image data.

According to an aspect of the present invention, an information processing apparatus comprises: a display unit configured to display an image including a plurality of objects on a screen; a generation unit configured to generate block information indicating information of blocks obtained by dividing the object for each attribute; an input unit configured to recognize handwriting of an annotation written on the image by hand; a detection unit configured to detect classification of the annotation based on the handwriting; and a display changing unit configured to estimate a partial region to focus based on a relation between the block information and the handwriting and dynamically change and display an expression of the partial region according to the classification of the annotation.

In the information processing apparatus according to the embodiment of the present invention, an intention of an expositor can be understood based on a handwritten annotation when the handwritten annotation is added to an image by the expositor, and an expression of a partial region of the image can be dynamically changed in accordance with an expression of the intention to be displayed.

Further features of the present invention will become apparent from the following description of exemplary embodiments with reference to the attached drawings.

### BRIEF DESCRIPTION OF THE DRAWINGS

FIG. 1 is a schematic diagram illustrating a case in which presentation is performed using an image display apparatus.

FIG. 2 is a hardware block diagram illustrating the image display apparatus.

FIG. 3 is a software block diagram illustrating the image display apparatus.

FIG. 4 is a diagram illustrating a screen display example of a touch UI of the image display apparatus.

FIG. 5 is a diagram illustrating an example of a result obtained by dividing an object.

FIG. 6 is a table illustrating block information and input file information of attributes.

FIGS. 7A to 7C are diagrams illustrating examples of handwritten annotations.

FIG. 8 is a flowchart for when application image data is reproduced.

FIG. 9 is a flowchart for when handwritten annotations are written.

FIG. 10 is a table illustrating an example of attribute information of the generated handwritten annotation.

FIG. 11 is a flowchart illustrating a handwritten annotation expression changing process.

FIGS. 12A to 12E are diagrams illustrating display examples when handwritten annotations are written.

FIGS. 13A to 13D are diagrams illustrating display examples when handwritten annotations are written.

FIG. 14 is a flowchart illustrating an enclosure line annotation expression changing process.

FIGS. 15A to 15F are diagrams illustrating display examples when enclosure line annotations are written.

FIG. 16 is a flowchart illustrating a process of changing display in real time.

FIGS. 17A to 17E are diagrams illustrating display examples when display is changed in real time.

### DESCRIPTION OF THE EMBODIMENTS

Hereinafter, embodiments of the present invention will be described with reference to the drawings.

### First Embodiment

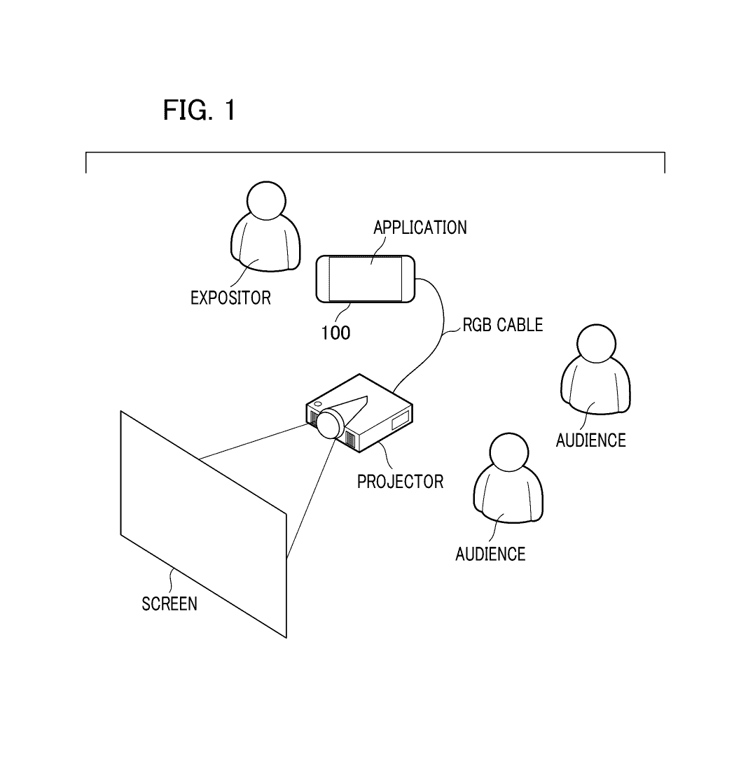

FIG. 1 is a diagram illustrating an image when presentation is performed using an image display apparatus 100 according to an embodiment. In the embodiment, presentation is assumed to be performed in a conference room in an office. An image display apparatus 100 may be an information processing apparatus, for example, a portable information terminal such as a smartphone or a tablet PC. An expositor manipulates an application of the image display apparatus 100 to display data with a predetermined format (hereinafter referred to as application image data). Since an application manipulation method is described below, the detailed description thereof will be omitted herein. The application image data displayed by the image display apparatus 100 is output as RGB (RED, GREEN, and BLUE) signals to a projector. Specifically, the projector and the image display apparatus 100 are connected via an RGB cable, and the RGB signals output from the image display apparatus 100 are input to the projector via the RGB cable. The projector projects the input RGB signals to a screen.

In the embodiment, the same application image data as the application image data displayed by the image display apparatus 100 is projected onto the screen. Accordingly, an audience can view the screen to browse the application image data displayed by the image display apparatus 100 together with a plurality of people. Here, the application image data projected from the image display apparatus 100 and the projector onto the screen may be generated and output separately so that two pieces of application image data for the expositor and the audience are displayed.

In the embodiment, the audience is assumed to browse the application image data through the screen, but may browse the application image data through a display internally included in the image display apparatus 100. In the embodiment, the image display apparatus 100 internally including a touch panel as an input unit is assumed. However, the present invention is not limited to the touch panel, but another input unit may be used as long as a manipulation of the image display apparatus 100, writing of an annotation on the application image data, and recognition of an annotation are possible.

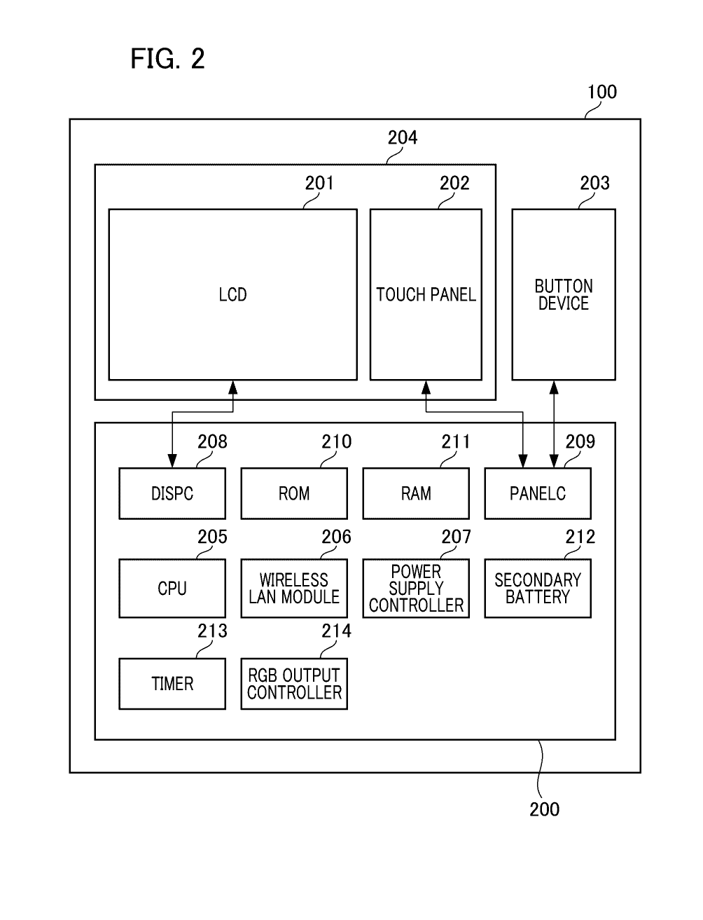

FIG. 2 is a block diagram illustrating a hardware configuration of the image display apparatus 100 according to the embodiment. The image display apparatus 100 is configured to include a main board 200, an LCD 201, a touch panel 202, and a button device 203. In the embodiment, the LCD 201 and the touch panel 202 are assumed to be collectively a touch UI 204. Constituent elements of the main board 200 include a CPU 205, a wireless LAN module 206, a power supply controller 207, and a display controller (DISPC) 208. The constituent elements further include a panel controller (PANELC) 209, a ROM 210, a RAM 211, a secondary battery 212, a timer 213, and an RGB output controller 214. The constituent elements are connected via a bus (not illustrated).

A central processing unit (CPU) 205 controls each device connected via the bus and loads a software module 300 stored in a read-only memory (ROM) 210 on the RAM 211 to execute the software module 300. The random access memory (RAM) 211 functions as a main memory of the CPU 205, a work area, a video image area displayed on the LCD 201, and a storage area for application image data.

The display controller (DISPC) 208 switches video image outputs loaded on the RAM 211 at a high speed according to a request from the CPU 205 and outputs a synchronization signal to the LCD 201. As a result, a video image of the RAM 211 is output to the LCD 201 in synchronization with the synchronization signal of the DISPC 208 so that the image is displayed on the LCD 201.

The panel controller (PANELC) 209 controls the touch panel 202 and the button device 203 according to a request from the CPU 205. Accordingly, the CPU 205 is notified of, for example, a position at which an indicator such as a finger or a stylus pen is pressed on the touch panel 202 or a key code pressed on the button device 203. Pressed-position information is formed from a coordinate value indicating the absolute position in the horizontal direction of the touch panel 202 (hereinafter referred to as an x coordinate) and a coordinate value indicating the absolute position in the vertical direction (hereinafter referred to as a y coordinate). The touch panel 202 can recognize a manipulation of a user and detect pressing of a plurality of points. In this case, the CPU 205 is notified of pressed-position information corresponding to the number of pressed positions.

The power supply controller 207 is connected to an external power supply (not illustrated) to be supplied with power. Accordingly, while the secondary battery 212 connected to the power supply controller 207 is charged, power is supplied to the entire image display apparatus 100. When no power is supplied from the external power supply, power from the secondary battery 212 is supplied to the entire image display apparatus 100.

The wireless LAN module 206 establishes wireless communication with a wireless LAN module on a wireless access point (not illustrated) connected to a LAN (not illustrated) constructed in an office (a facility or the like) and relays communication with the image display apparatus 100 under the control of the CPU 205. The wireless LAN module 206 may be, for example, IEEE 802.11b.

The timer 213 generates timer interruption of a gesture event generation unit 301 under the control of the CPU 205. A geomagnetic sensor (not illustrated) and an acceleration sensor (not illustrated) are included in the image display apparatus 100 and are each connected to a bus. The timer 213 detects an inclination of the image display apparatus 100 under the control of the CPU 205. When an inclination equal to or greater than a predetermined inclination of the image display apparatus 100 is obtained, the direction of the image display apparatus 100 is changed and a drawing instruction to the LCD 201 is transmitted to a drawing unit 303. When the direction of the image display apparatus 100 is changed, the CPU 205 interchanges the width and height of the LCD 201 and executes a subsequent process.

That is, the RGB output controller 214 switches the video image output loaded on the RAM 211 at a high speed and transmits an RGB video image signal to an external display apparatus such as a projector. As a result, the video image of the RAM 211 is output to the external display apparatus such as a projector and the same image as the LCD 201 is displayed on a screen onto which an image is projected by the projector.

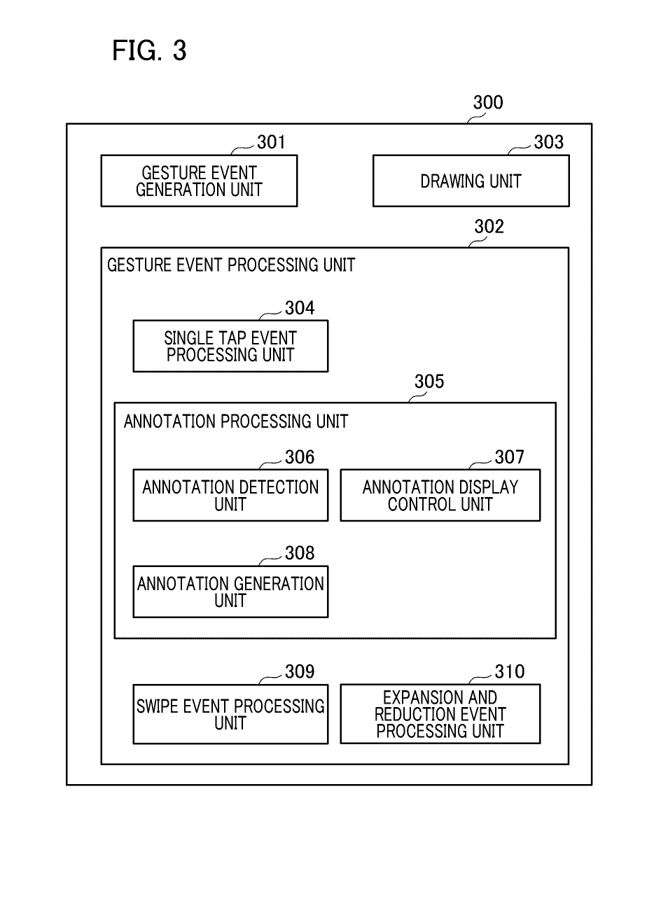

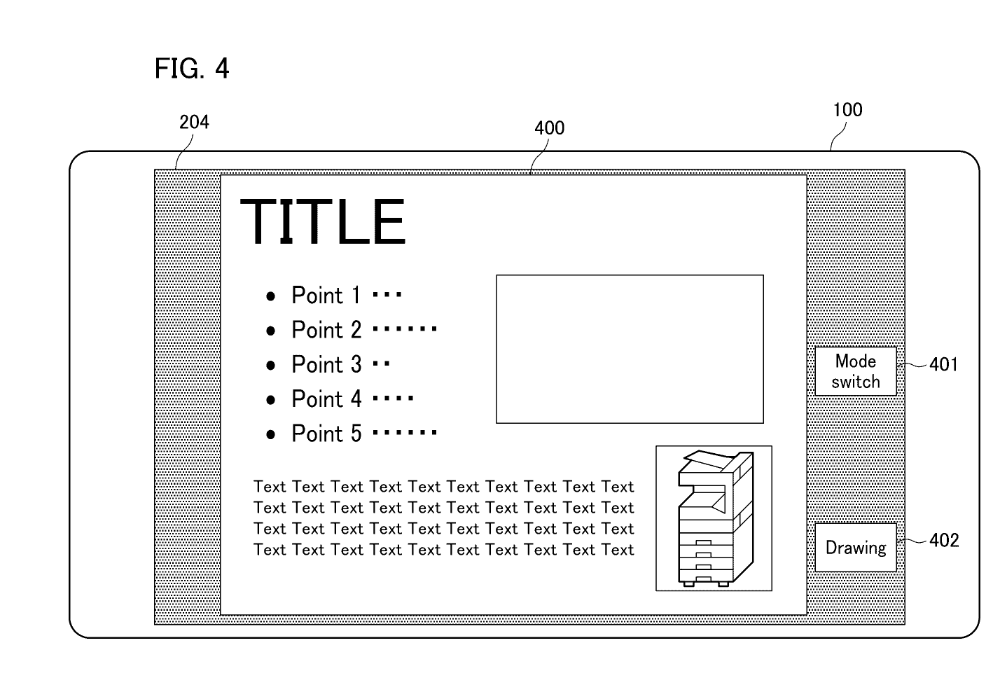

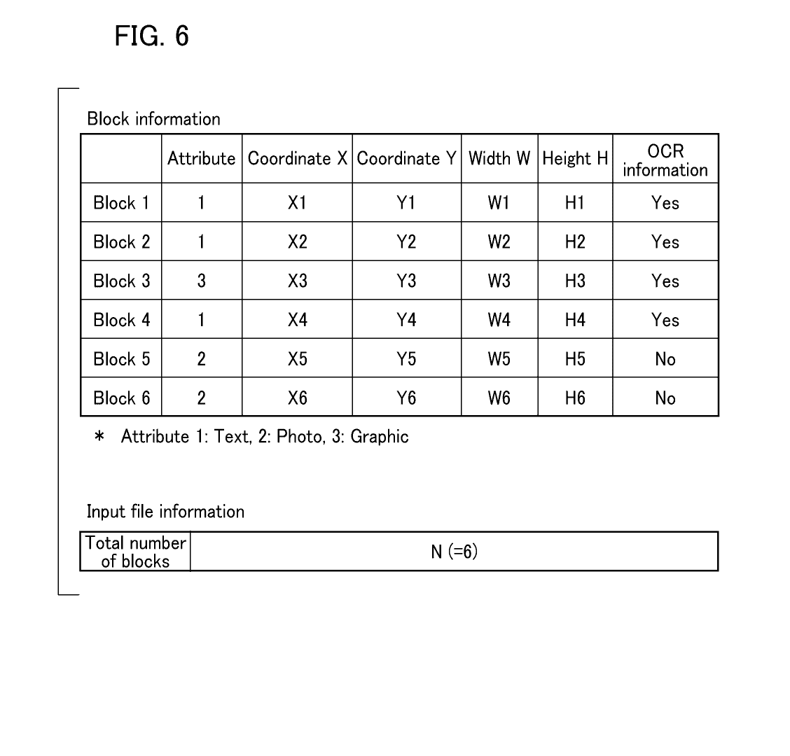

Next, a software module related to manipulation control of the application image data of the image display apparatus 100 according to the embodiment will be described with reference to FIGS. 3, 4, and 6. FIG. 3 is a block diagram illustrating the configuration of the software module 300 executed and processed by the CPU 205 of the image display apparatus 100. FIG. 4 is a diagram illustrating a screen display example of the touch UI 204 of the image display apparatus 100 according to the embodiment. FIG. 6 is a table illustrating examples of classification of handwritten annotations.

First, modules included in the software module 300 will be described. The gesture event generation unit 301 receives touch inputs of the user, generates various gesture events, and transmits the generated gesture events to a gesture event processing unit 302. The various gesture events are gesture events such as a touch pressing event, a touch releasing event, a single tap event, a double tap event, a swipe event, a pinch-in event, a pinch-out event. Here, the various gesture events will be described.

In the touch pressing event, coordinate values of recent touch coordinates and the number of pairs of touch coordinates are transmitted to the gesture event processing unit 302. The touch coordinates are coordinates of one point touched by a finger of the user on the touch panel 202 and have a pair of coordinate values expressed by x and y coordinates. The number of pairs of touch coordinates indicates the number of pairs of touch coordinates touched by a finger of the user on the touch panel 202. The touch coordinates are updated when the user touches his or her finger on the touch panel 202, the user moves his or her finger, and the user removes his or her finger, and an interrupt is generated from the timer 213.

In the touch releasing event, coordinate values of recent touch coordinates and the number of pairs of coordinates when the user removes his or her finger from the touch panel 202 are transmitted to the gesture event processing unit 302. In the single tap event, coordinate values of recent touch coordinates are transmitted to the gesture event processing unit 302. A single tap indicates that a touch releasing event is generated within a predetermined time after the above-described touch pressing event. In the double tap event, coordinate values of recent touch coordinates are transmitted to the gesture event processing unit 302. A double tap indicates that the above-described single tap event is generated twice within a predetermined time.

Next, in the swipe event, coordinate values of recent touch coordinates and a movement distance calculated from differences between the recent and immediately previous coordinate values are transmitted. A swipe is an operation of moving (sliding) a fingertip in one direction with the fingertip touching the touch panel 202. In the pinch-in event, a pinch-in reduction ratio calculated from the central coordinate values of the touch coordinates of two recent points and a reduced distance of a straight line connecting the touch coordinates of the two points is transmitted. A pinch-in is an operation of bringing two fingertips closer to each other (pinching) with the fingertips touching the touch panel 202. In the pinch-out event, a pinch-out expansion ratio calculated from the central coordinate values of the touch coordinates of two recent points and an expanded distance of a straight line connecting the touch coordinates of the two points is transmitted. A pinch-out is an operation of moving two fingertips away from each other (spreading fingers) with the fingertips touching the touch panel 202. Since mechanisms of generating the above-described gesture events are known technologies, the mechanisms will not be described in any further detail.

The gesture event processing unit 302 receives the gesture events generated by the gesture event generation unit 301 and executes manipulation control according to each gesture event and a document structure described in the application image data. The drawing unit 303 draws the application image data on the LCD 201 according to an execution result of the gesture event processing unit 302. A method of displaying the application image data will be described below.

When the single tap event is received, a single tap event processing unit 304 determines whether the coordinate values of the touch coordinates of the single tap event are on a mode switch button 401 or a drawing button 402 illustrated in FIG. 4. When the touch coordinates of the single tap event are on the mode switch button 401, a mode switching process to be described below is performed. When the touch coordinates are on the drawing button 402, an annotation process to be described below is performed. The annotation process is performed in an annotation processing unit 305.

When the single tap event processing unit 304 determines that the drawing button 402 is single-tapped, the annotation processing unit 305 receives the touch pressing event and the touch releasing event on a page 400 illustrated in FIG. 4. Then, a process related to a handwritten annotation is performed based on coordinate data (that is, handwriting of the expositor) of each event.

An annotation detection unit 306 detects classification of the handwritten annotations based on the pieces of coordinate data (handwriting of the expositor) of the touch pressing event and the touch releasing event. Specifically, as the classification of the handwritten annotations, there are a character string, an underline, a cancellation line, and an enclosure line. However, the classification of the handwritten annotation is not limited thereto, but an arrow, a leading line, and the like can also be detected.

The classification of the handwritten annotation is detected by determining the shape of the handwritten annotation based on the coordinate data of the handwritten annotation. Specifically, when the classification of the handwritten annotation is an enclosure line, it is determined whether the handwritten annotation is one stroke. When the handwritten annotation is one stroke, a distance between the starting point and the ending point of the coordinate values of the handwritten annotation is calculated. When this distance is less than the entire length of the stroke of the handwritten annotation, the classification of the handwritten annotation is determined to be a closed loop (an enclosure line). When the classification of the handwritten annotation is determined not to be the closed loop, it can be determined whether the recognized handwriting is a straight line by solving a known straight-line regression problem. By further finding whether the absolute value of an inclination of the straight line is equal to or less than a given value, it is possible to determine whether the straight line is a horizontal line.

When the straight line is determined to be the horizontal line, it is determined whether a character string object (a partial region to focus) is in an upper portion or a middle portion of the vicinity of the horizontal line. When the character string object is in the upper portion of the vicinity of the horizontal line, the handwritten annotation is determined to be an underline of the character string object. When the character string object is in the middle portion of the vicinity of the horizontal line, the handwritten annotation is determined to be a cancellation line of the character string object. Whether the character string object is in the upper portion or the middle portion of the vicinity of the horizontal line can be obtained from positional information of the character string object detected at the time of generation of the application image data, as will be described below.

That is, the coordinate data and the size of the character string object are compared to the coordinate data of the horizontal line. When the coordinate data of the horizontal line is entirely below the lower portion of the character string object, the handwritten annotation is determined to be an underline. When the coordinate data of the horizontal line is entered within upper and lower predetermined values of middle coordinate data of the character string object, the handwritten annotation is determined to be a cancellation line. Since a method of detecting the classification of the handwritten annotation is a known technology (Japanese Patent Laid-Open No. 2014-102669), further detailed description thereof will be omitted.

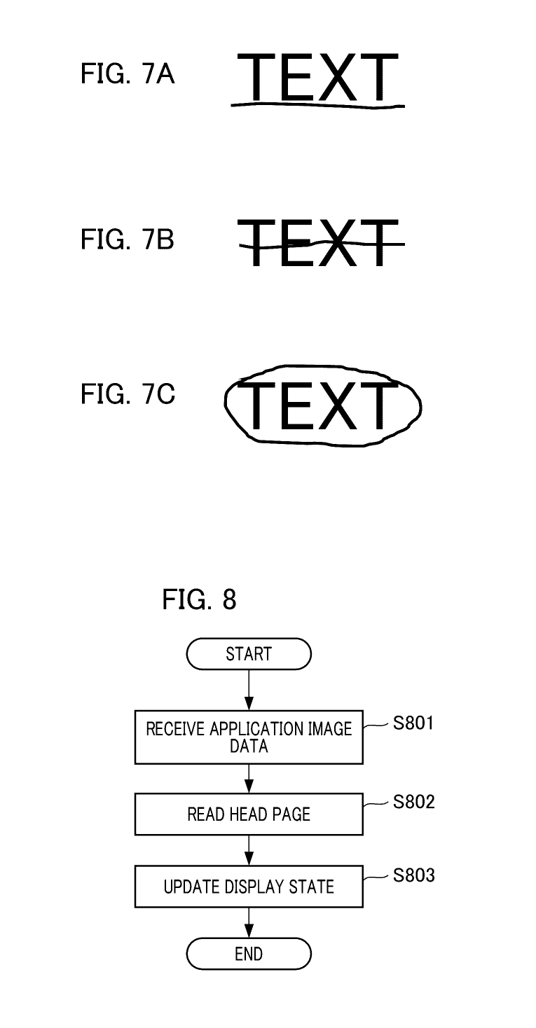

Here, FIGS. 7A to 7C will be described. FIGS. 7A to 7C are diagrams illustrating examples of the classification of the handwritten annotation. In FIGS. 7A to 7C, handwritten annotations are attached to a character string object on application image data such as TEXT. An underline, a cancellation line, and an enclosure line are illustrated in FIGS. 7A, 7B, and 7C, respectively. These lines are classified through the detection of the classification of the handwritten annotations described above.

Here, description will return to FIG. 3. An annotation display control unit 307 performs a display changing process according to the classification of the handwritten annotation detected by the annotation detection unit 306 and a handwritten annotation drawing process based on the coordinate values (handwriting of the expositor) of the touch pressing event and the touch releasing event. The description herein will be omitted to describe the details below. An annotation generation unit 308 generates an annotation object based on the coordinate values (handwriting of the expositor) of the events, the touch pressing event and the touch releasing event, and the classification of the handwritten annotation detected by the annotation detection unit 306.

A swipe event processing unit 309 performs a process on the swipe event. When the swipe event is received, the gesture event processing unit 310 moves the starting point of the page 400 at the coordinates on the touch UI 204 according to a movement distance of the swipe event. Then, a display state of the touch UI 204 thereon is updated. An expansion and reduction event processing unit 302 performs a process on the pinch-in event and the pinch-out event. When the pinch-in event or the pinch-out event is received, the gesture event processing unit 302 controls a page starting point and a display magnification of the page 400 according to a reduction ratio or an expansion ratio of the above-described two events and subsequently updates the display state of the touch UI 204.

Next, a method of generating application image data which is data with a predetermined format displayed by the image display apparatus 100 will be described. The application image data is acquired by an image reading unit of an MFP (not illustrated) which is a multifunction machine realizing a plurality of functions (a copy function, a printing function, a transmission function, and the like). Alternatively, the application image data is generated by rendering a document generated by application software on a client PC (not illustrated) in the MFP. The MFP and the client PC are connected to a LAN (not illustrated) constructed in an office (a facility or the like) and can mutually transmit and receive data.

First, an object division process of dividing bitmap image data acquired by the image reading unit of the MFP or generated by an application of the client PC into objects of respective attributes is performed. The kinds of attributes of the objects after the object division indicate text, photos, and graphics (drawings, line drawings, tables, and lines). The kinds (text, photos, and graphics) of divided objects are each determined.

Next, it is determined whether the objects are text. When the objects are text, an OCR process is performed to acquire character-coded data (character code data of an OCR result). Since the OCR is a known technology, the detailed description thereof will be omitted. In each of the divided objects, the region of the object is cut from the bitmap image data using positional information regarding the object to generate an object image. The object image is subjected to resolution conversion according to the kind of attribute of the object so that preferred image quality is maintained while a data amount is suppressed.

Next, the bitmap image data is subjected to resolution conversion to generate a background image having a lower resolution than the bitmap image data. In the embodiment, the background image having a ¼ resolution, that is, the background image having 150 dpi when the bitmap image data is 600 dpi, is generated using a nearest neighbor method.

The resolution conversion method is not limited to the nearest neighbor method. For example, a high-precision interpolation method such as a bilinear method or a bicubic method may be used. Then, a background image compressed by JPEG is generated using the background image having the lower resolution than the generated bitmap image data. The data of each object, the data of the background image, and the character code data are acquired based on a document structure tree to be described below to generate the application image data which can be displayed by the image display apparatus 100. Since a method of generating the application image data is a known technology (Japanese Patent Laid-Open No. 2013-190870), further detailed description thereof will be omitted.

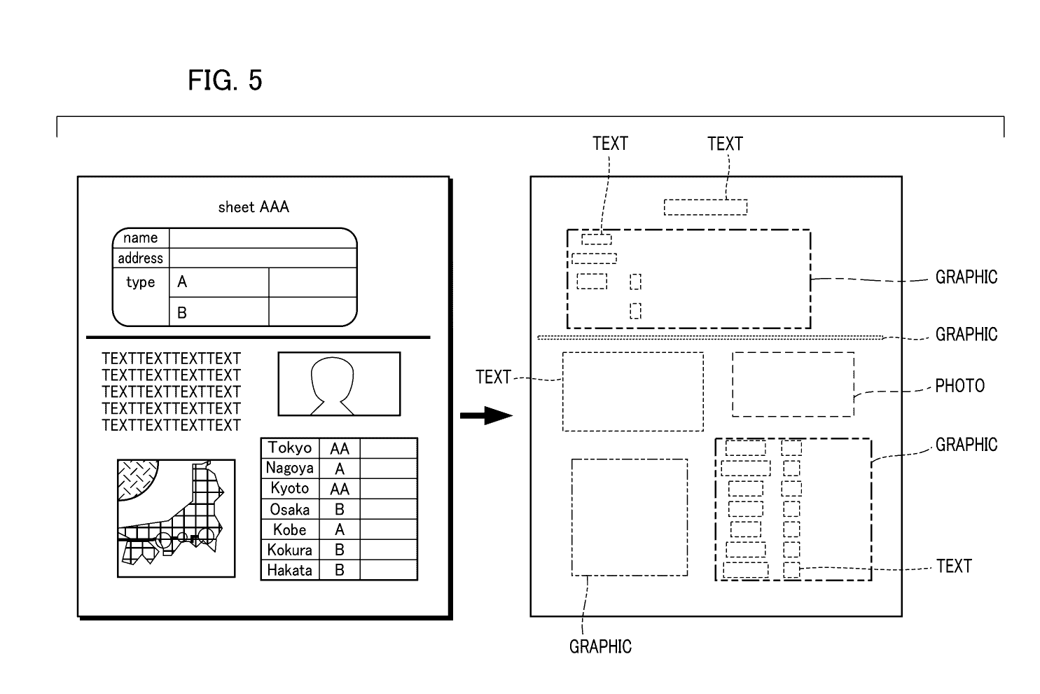

The object division will be described in detail with reference to FIGS. 5 and 6. FIG. 5 is a diagram illustrating an example of a result obtained by dividing the bitmap image data into a plurality of objects through the object division process. FIG. 6 is a table illustrating block information and input file information regarding the objects when the object division is performed.

First, an input image (the left side of FIG. 5) is divided into rectangular blocks (the right side of FIG. 5) for each attribute by performing the object division process. As described above, as the attributes of the rectangular blocks, there are text, photos, graphics (drawings, line drawings, tables, and lines), and the like. The following is one example of a method of the object division process.

First, image data stored in a RAM (not illustrated) in the MFP is binarized to black and white and a pixel mass surrounded by a black pixel contour is extracted. Then, the size of a black pixel mass is evaluated and contour tracking is performed on a white pixel mass inside the black pixel mass having a size equal to or greater than a predetermined value. As in evaluation of the size of the white pixel mass and tracking of the inner black pixel mass, extraction of an inner pixel mass and contour tracking are performed recursively as long as an inner pixel mass is equal to or greater than a predetermined value. The size of a pixel mass is evaluated, for example, by the area of the pixel mass. A rectangular block circumscribed around the pixel mass obtained in this way is generated and the attribute is determined based on the size and shape of the rectangular block.

For example, a rectangular block of which an aspect ratio is near 1 and a size is in a given range is assumed to be a text-equivalent block which is likely to be a text region rectangular block. When the approaching text-equivalent blocks are aligned with regularity, a new rectangular block in which the text-equivalent blocks are collected is generated. The new rectangular block is assumed to be a text region rectangular block. A black pixel mass that contains a white pixel mass having a size equal to or greater than a given size and a rectangle with good alignment or a flat pixel mass is assumed to be a graphic region rectangular block and other amorphous pixel masses are assumed to be photo region rectangular blocks.

For each of the rectangular blocks generated in this way, the block information such as attributes and the input file information illustrated in FIG. 6 are generated. In FIG. 6, the block information includes attributes, coordinates X and Y of the position, a width W, a height Y, and OCR information of each block. The attributes are given as numerical values of 1 to 3. In the embodiment, 1 indicates a text region rectangular block, 2 indicates a photo region rectangular block, and 3 indicates a graphic region rectangular block.

The coordinates X and Y are X and Y coordinates of a starting point (the coordinates of the upper left corner) of each rectangular block in the input image. The width W and the height H are the width of the rectangular block in the X coordinate direction and the height of the rectangular block in the Y coordinate direction. The OCR information indicates whether there is pointer information to character-coded data formed through the OCR process. Further, the total number N of blocks indicating the number of rectangular blocks is also restored as the input file information.

The block information regarding each rectangular block is used to generate the application image data. A relative positional relation at the time of overlapping of a specific region and another region can be specified in accordance with the block information, and thus regions can overlap without impairing the layout of the input image. Since the object division method is a known technology (Japanese Patent Laid-Open No. 2013-190870), further detailed description thereof will be omitted.

Next, a process when the image display apparatus 100 reproduces the application image data according to the embodiment will be described with reference to FIGS. 4 and 8. FIG. 8 is a flowchart for when the image display apparatus 100 reproduces the application image data. First, in step S801, when the application image data is received from the MFP via the wireless LAN module 206, the image display apparatus 100 stores the received application image data in the RAM 211.

Next, in step S802, the syntax of the application image data stored in the RAM 211 is analyzed and the head page is read. Next, in step S803, the drawing unit 303 renders the background included in the read head page according to the coordinates, the width, and the height of the starting point of the region information and updates the display state of the touch UI 204. At this time, as illustrated on the page 400 in FIG. 4, a display magnification of the head page is controlled such that the height of the page 400 matches the height of the touch UI 204 and the width of the page 400 matches the width of the touch UI 204. When the width or height of the page reduced at the display magnification is less than that of the touch UI 204, the starting point of the page 400 is controlled at the coordinates on the touch UI 204 so that the page is displayed in the middle of the touch UI 204.

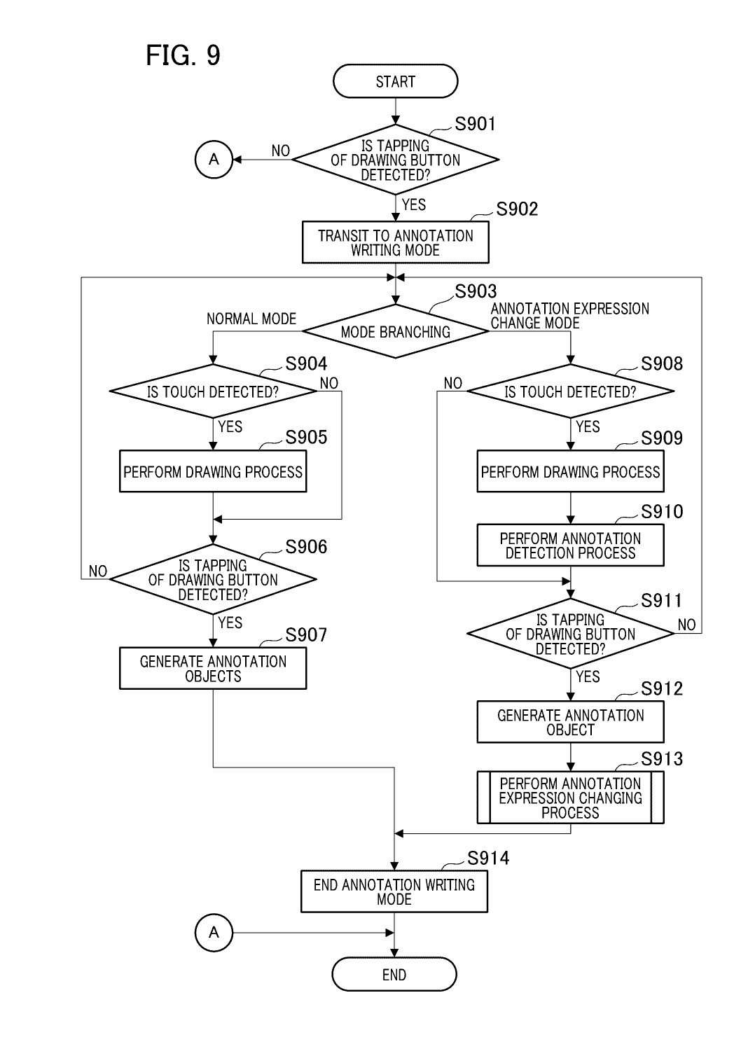

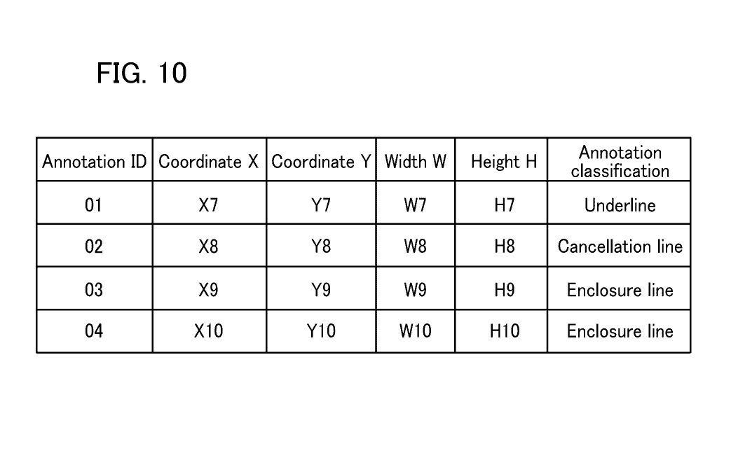

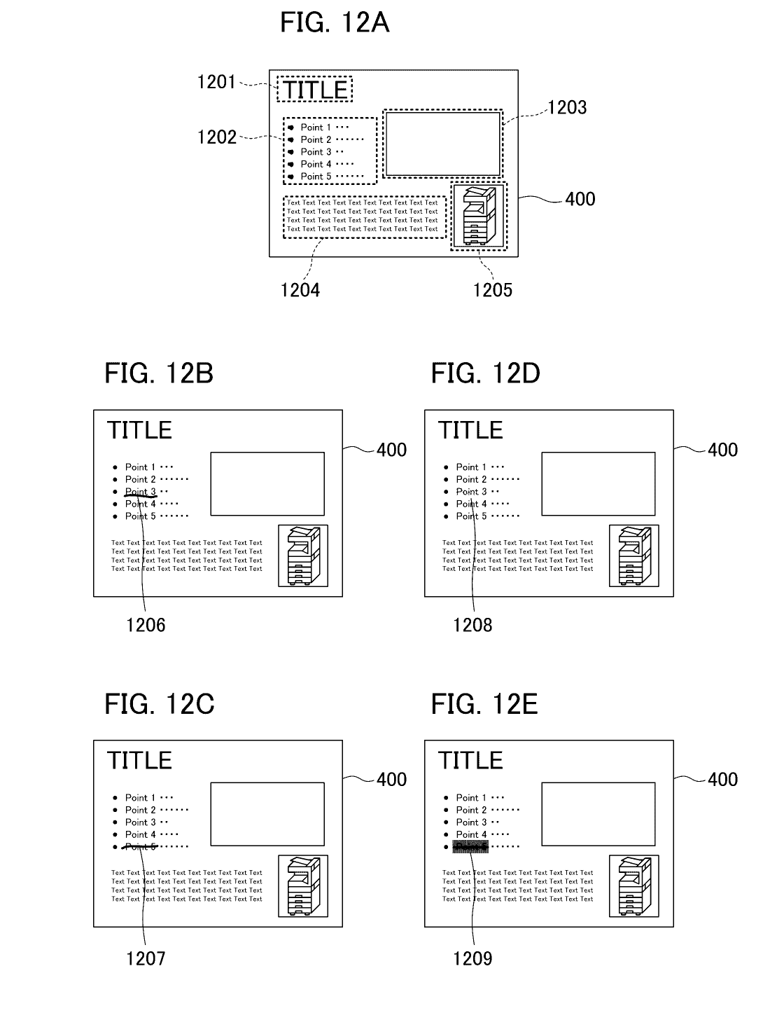

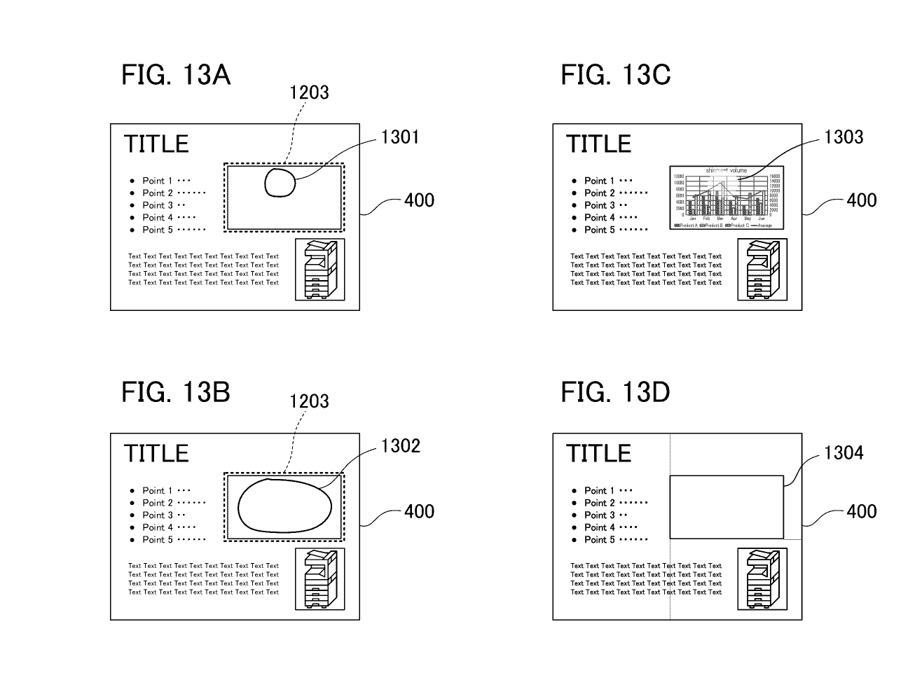

Next, an operation at the time of writing of annotations will be described with reference to FIGS. 9, 10, 12A to 12E, and 13A to 13D. FIG. 9 is a flowchart for when the annotations are written. FIG. 10 is a table illustrating examples of handwritten annotation attribute information according to the embodiment. FIGS. 12A to 12E and 13A to 13D are diagrams illustrating examples in which expressions of partial regions in an image are dynamically changed and displayed in display of the application image data according to the embodiment. Steps S901 to S914 of FIG. 9 are executed and processed by the software module 300.

First, in step S901, it is determined whether the drawing button 402 on the touch UI 204 is single-tapped. When the drawing button 402 is tapped (YES), the process proceeds to step S902. Conversely, when the drawing button 402 is not tapped (NO), the process ends. Next, in step S902, a mode transitions to an annotation writing mode. At the time of the annotation writing mode, all gesture manipulations on the page 400 are determined as handwritten annotation writing.

When the mode is not the annotation writing mode, the handwritten annotation writing on the page 400 is not performed and the swipe event, the pinch-out event, or the like is received. The transition to the annotation writing mode and the end of the annotation writing mode can be performed through the single tap of the drawing button 402.

Next, step S903 is a mode branch. At the time of a normal mode, the process proceeds to step S904. At the time of an annotation expression change mode, the process proceeds to step S908. Here, the normal mode indicates a mode in which the expression of the partial region of the image is not dynamically changed in accordance with the annotation. That is, the normal mode is the mode in which a trajectory formed when the user touches his or her finger on the page 400 remains as handwriting on the page 400 without change. Specifically, annotations 1206, 1207, 1301, and 1302 illustrated in FIGS. 12A to 12E and 13A to 13D are examples of the handwritten annotations that remain as handwriting when the finger touches the page 400.

The thickness or color of the handwriting can be set in advance by the user to be freely selected. On the other hand, the annotation expression change mode is a mode in which an intention of the expositor is comprehended from the attribute of the object and the handwritten annotation added on the image and the expression of the partial region of the image is dynamically changed so that the expression matches the intention. Since the details of the annotation expression change mode are described below, the description thereof will be omitted here. The normal mode and the annotation expression change mode can be alternately switched at any time by single-tapping the mode switch button 401 on the touch UI 204.

Next, in step S904, a touch of the user on the page 400 is detected. When the touch is detected (YES), the process proceeds to step S905. Conversely, when the touch is not detected (NO), the process proceeds to step S906. Then, in step S905, the drawing process is performed in the portion of the touch UI 204 touched by the annotation display control unit 307. Since a technology for detecting the touch on the touch UI 204 and performing the drawing process in the touched portion on the LCD 201 is a known technology, the detailed description will be omitted.

Next, in step S906, it is detected whether the drawing button 402 is single-tapped on the touch UI 204 again. When the drawing button 402 is single-tapped (YES), the process proceeds to step S907. Conversely, when the drawing button 402 is not tapped (NO), the process returns to step S903. Then, in step S907, the annotation objects are generated by the annotation generation unit 308. For example, reference numeral 1206 in FIG. 12B denotes an example of the annotation object. The annotation object has the attribute information illustrated in FIG. 10.

Here, annotation attribute information illustrated in FIG. 10 will be described. A region of the annotation object is expressed with a rectangle that touches both upper and lower ends and both right and left ends of coordinate data of a written annotation. The coordinates X and Y illustrated in FIG. 10 indicate the position of the upper left end of the rectangle. The width W and the height H respectively indicate the length of the rectangle representing the annotation object in the X axis direction and the length of the rectangle in the Y axis direction. The annotation classification illustrated in FIG. 10 is handwritten annotation classification detected in step S910 at the time of the annotation expression change mode. Since the annotation detection process is not performed in step S907, the annotation classification is empty.

Annotation IDs 01, 02, 03, and 04 illustrated in FIG. 10 respectively correspond to annotations 1206, 1207, 1301, and 1302 illustrated in FIGS. 12A to 12E and 13A to 13D. The annotation objects are different from the objects included in the application image data described with reference to FIGS. 5 and 6 and refer to handwritten annotations displayed in different layers overlapping with layers of the application image data. To facilitate the description, when the objects are simply called handwritten annotations or annotations, the objects indicate the annotation objects. When the objects are called objects, the objects indicate the objects included in the application image data.

Here, description will return to FIG. 9. In step S908, the touch of the user on the page 400 at the time of the annotation expression change mode is detected. When the touch is detected (YES), the process proceeds to step S909. Conversely, when the touch is not detected (NO), the process proceeds to step S911. Then, in step S909, the drawing process is performed in the portion touched on the touch UI 204, as in step S905. In step S910, the handwritten annotation detection process is performed by the annotation detection unit 305. Since the specific detection process has been described with regard to the above-described annotation detection unit 305, the description will be omitted herein. The detected result is used to generate the annotation objects in step S912 to be described below.

Next, in step S911, it is detected whether the drawing button 402 on the touch UI 204 is single-tapped again. When the drawing button 402 is single-tapped (YES), the process proceeds to step S912. Conversely, when the drawing button 402 is not single-tapped, the process returns to S903. Then, in step S912, the annotation objects are generated by the annotation generation unit 308 as in step S907. In step S912, in addition to the process of step S907, the annotation attribute information is generated by adding the result of the annotation detection process of step S910.

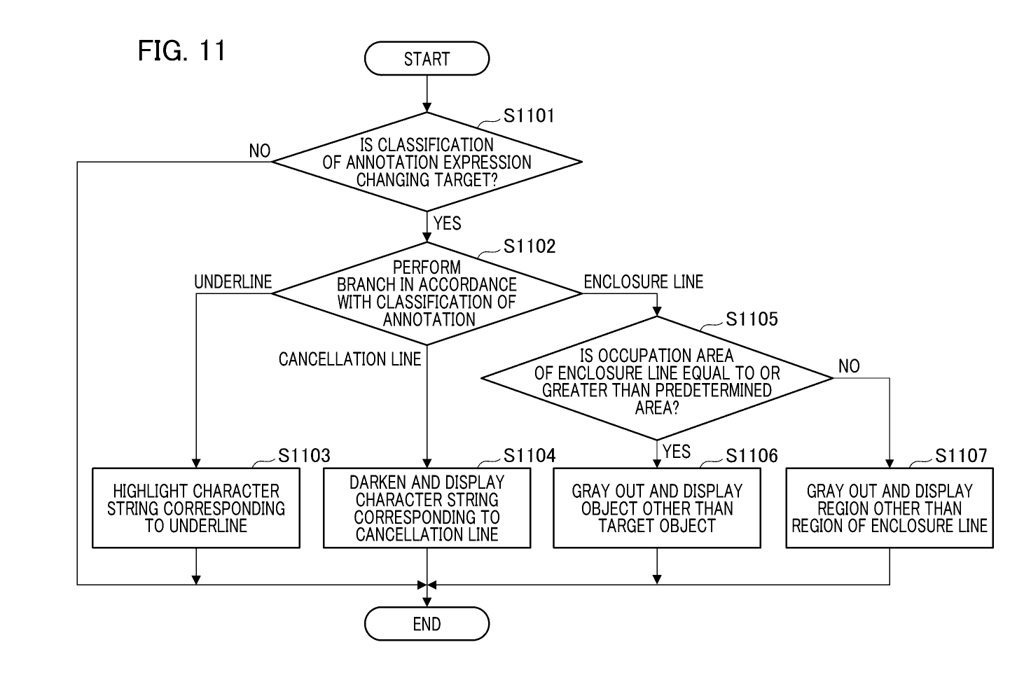

Next, in step S913, the annotation expression changing process is performed. The annotation expression changing process is performed according to the attribute information (the attributes in FIG. 6) of the objects on the page 400 and the attribute information (the attributes in FIG. 10) of the annotations. Since the details are described with reference to the flowchart of FIG. 11, the description thereof will be omitted here. Then, in step S914, the annotation writing mode ends and the present process ends.

Next, the annotation expression changing process will be described with reference to FIGS. 10, 11, 12A to 12E, and 13A to 13D. FIG. 11 is a flowchart for describing the details of the annotation expression changing process of step S913 illustrated in FIG. 9. Steps S1101 to S1107 illustrated in FIG. 11 are executed and processed by the annotation display control unit 307.

First, in step S1101 illustrated in FIG. 11, based on the attribute information regarding the handwritten annotations illustrated in FIG. 10, it is determined whether the classification of the handwritten annotation is an expression changing target. Specifically, when the classification of the handwritten annotation is one of an underline, a cancellation line, and an enclosure line, the classification is the expression changing target and the other classification is excluded from the expression changing target. When the classification of the handwritten annotation is the expression changing target (YES), the process proceeds to step S1102. Conversely, when the classification of the handwritten annotation is not the expression changing target (NO), the present process ends.

Next, step S1102 is a branch in accordance with the classification of the handwritten annotation. When the classification of the handwritten annotation illustrated in FIG. 10 is the underline, the process proceeds to step S1103. When the classification of the handwritten annotation is the cancellation line, the process proceeds to step S1104. When the classification of the handwritten annotation is the enclosure line, the process proceeds to step S1105. Then, in step S1103, text corresponding to the underline detected in step S910 is highlighted and displayed.

Specifically, the text region is displayed more conspicuously by erasing the annotation of the original handwritten input and changing the background color of the corresponding text region into a chromatic color. For example, a partial region 1208 illustrated in FIG. 12D indicates an example in which the handwritten annotation 1206 of the underline which is the handwritten input illustrated in FIG. 12B is highlighted and displayed. That is, since the underline of the handwritten annotation 1206 illustrated in FIG. 12B is determined to be an underline for a character string written as “Point 3” through the annotation detection process, “Point 3” is highlighted and displayed.

Here, the reason for which the character string corresponding to the underline is highlighted and displayed will be described. In general, when a handwritten annotation such as an underline for a character string on a material is added, an intention of the expositor is a desire that the character string be emphasized and conspicuous. Accordingly, based on a positional relation between the region of the character string and the added handwritten annotation, the expression of the character string is subjected to dynamic adjustment and change so that the character string is shown with emphasis. As an example of the adjustment and the change applied as the expression effects, a fine straight line underline is affixed to the character string in some cases.

As in the embodiment, the background color of the character string is changed to be conspicuous in some cases. Further, a foreground color (that is, a text color) is changed to be conspicuous in some cases. As another example, the character string is set to be relatively conspicuous in some cases by lowering the chroma or lightness of a region other than the character string. As described above, as an expression method of highlighting the character string to which the underline is affixed, all of the methods of causing the character string to be conspicuous can be applied. The expression method is not limited to the method according to the embodiment.

Next, in step S1104, the background color of the character string corresponding to the cancellation line detected in step S910 is darkened to be displayed. Specifically, the expression of the cancellation line is changed by replacing the annotation of the original handwritten input with a straight line and changing the background color of the corresponding text region into an achromatic color such as gray. For example, reference numeral 1209 illustrated in FIG. 12E denotes an example of the darkened and displayed annotation 1207 of the cancellation line which is the handwritten input illustrated in FIG. 12C.

Since the cancellation line of the handwritten annotation 1207 illustrated in FIG. 12C is determined to be the cancellation line for the character string written as “Point 5” through the annotation detection process, the background of “Point 5” is darkened and displayed. Here, in general, when the handwritten annotation such as the cancellation line for the character string on the material is added, an intention of the expositor is a desire that the character string be corrected or erased or not be conspicuous. Accordingly, based on a positional relation between the region of the character string and the added handwritten annotation, the expression of the character string is subjected to dynamic adjustment and change so that the character string is not shown conspicuously.

Next, in step S1105, it is determined whether an area of the enclosure region occupying the object region is equal to or greater than a predetermined area. Specifically, an overlap between the handwritten annotation region of the enclosure line and the object region is calculated. When the handwritten annotation region of the enclosure line occupies 70% or more of the entire object region, the area of the enclosure region is determined to be equal to or greater than the predetermined area. When there is no object in the region of the enclosure line, the overlap of each region is determined to be 0%.

For example, the handwritten annotation 1302 illustrated in FIG. 13B is determined to occupy the predetermined area (70%) or more of the region (a region indicated by a dotted line) of the object 1203. The handwritten annotation 1301 illustrated in FIG. 13A is determined not to occupy the predetermined area or more of the region of the object 1203. The predetermined area can be freely changed by the user and is not limited to 70%. When the annotation of the enclosure line occupies the predetermined area or more of the object (YES), the process proceeds to step S1106. Conversely, when the annotation of the enclosure line does not occupy the predetermined area or more (is less than the predetermined area) of the object (NO), the process proceeds to step S1107.

Next, in step S1106, a region other than the region of the object for which the handwritten annotation of the enclosure line is determined to occupy the predetermined area or more is grayed out and displayed. Specifically, by graying out and displaying the region other than the region of the object 1304, as illustrated in FIG. 13D, the object 1304 is displayed more conspicuously. In step S1107, the region other than the handwritten annotation of the enclosure line is grayed out and displayed. Specifically, by graying out and displaying the region other than the handwritten annotation 1303, as illustrated in FIG. 13C, the region surrounded by the handwritten annotation is displayed more conspicuously.

In the processes of steps S1105 to S1107 described above, it is determined that the entire object is emphasized and displayed when the entire object is designated by the enclosure line. Then, when a partial region in the object is determined to be designated, the partial region of the object is emphasized and displayed. In general, when the handwritten annotation such as the enclosure line for the region on the material is added, an intention of the expositor is a desire that the region be emphasized or conspicuous. Accordingly, based on a positional relation between the region and the handwritten annotation, the expression of the region is subjected to dynamic adjustment and change so that the character string is shown conspicuously.

According to the embodiment, as described above, it is possible to dynamically change the display of the partial region of the image so that the expression matches the intention of the expositor based on the annotation added to the image and the attribute of the object and to realize proper effective display in presentation.

### Second Embodiment

In the first embodiment, the example in which the annotation processing unit 305 dynamically changes the expression of the partial region of the image according to the attribute of the object and the classification of the annotation has been described. Accordingly, since the expression according to the intention of the expositor is possible, the proper effective display for presentation is possible. In the embodiment, an example in which an expression of the partial region of the image is dynamically changed when an enclosure line is in a text region, a photo region, or a graphic region will be described.

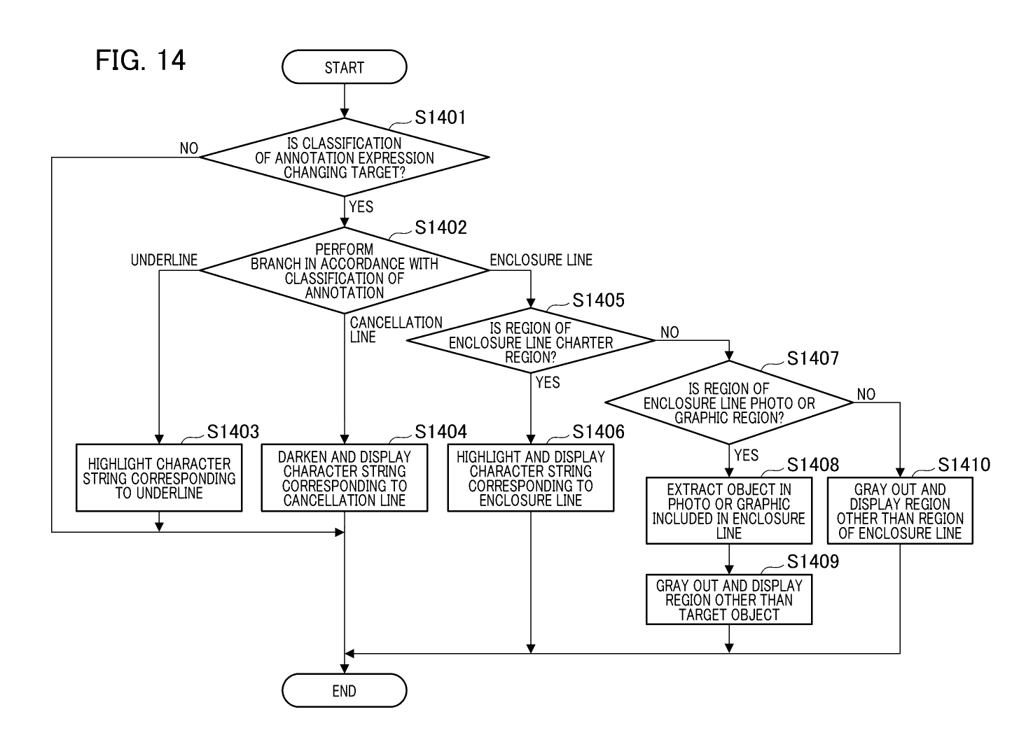

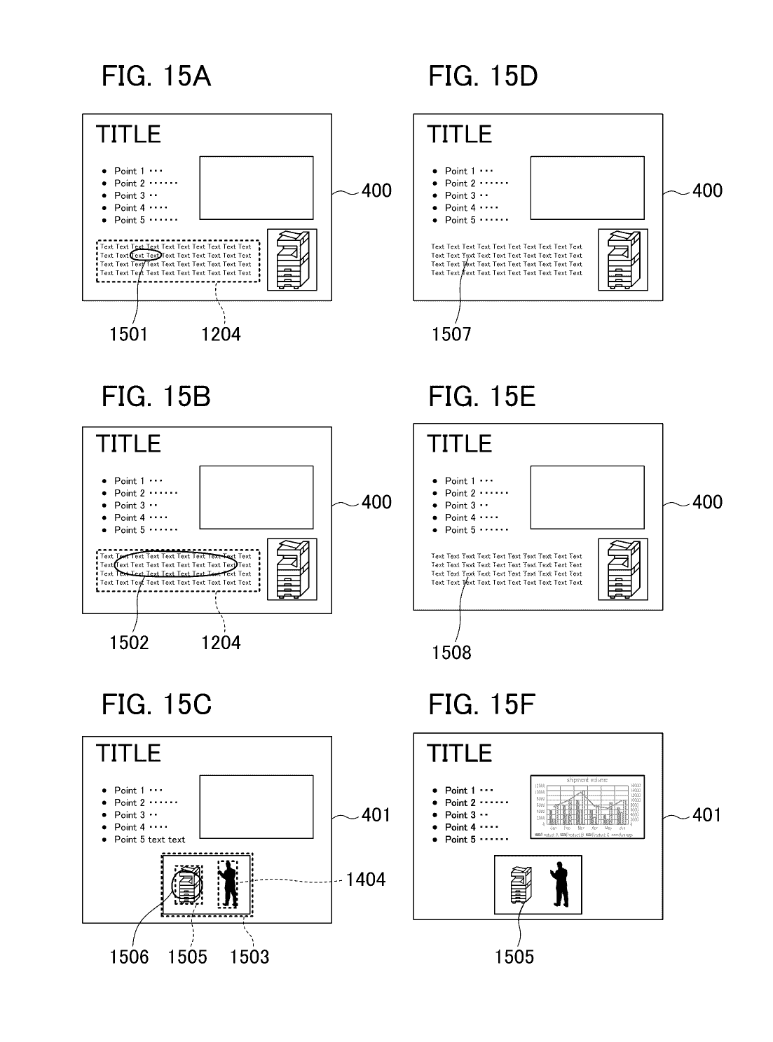

Hereinafter, differences from the first embodiment will be mainly described with reference to FIGS. 14 and 15A to 15F. FIG. 14 is a flowchart for describing the details of the annotation expression changing process of step S913 of FIG. 9 according to the embodiment. Step S1401 to step S1410 of FIG. 14 are executed and processed by the annotation display control unit 307. FIGS. 15A to 15F illustrate examples in which an expression of a partial region in an image is dynamically changed when a handwritten annotation of an enclosure line is written during display of application image data according to the embodiment.

Since steps S1401 to S1404 and S1410 illustrated in FIG. 14 are the same processes as steps S1101 to S1104 and S1107 illustrated in FIG. 9, the detailed description thereof will be omitted. First, in step S1405, it is determined whether the region of the enclosure region is a text region rectangular block. For example, an object 1204 on a page 400 illustrated in FIGS. 15A and 15B is a text region rectangular block and the regions of handwritten annotations 1501 and 1502 of the enclosure lines are determined to be in the text region rectangular blocks.

Specifically, when 80% or more of the region of the handwritten annotation of the enclosure line is included in the text region rectangular block, the annotation of the enclosure line is determined to be in the text region rectangular block. Here, the threshold value is a value which can be arbitrarily changed and is not limited to 80%. When the annotation of the enclosure line is determined to be in the text region rectangular block (YES), the process proceeds to step S1406. Conversely, when the annotation of the enclosure line is determined not to be in the text region rectangular block (NO), the process proceeds to step S1407.

Next, in step S1406, the text region corresponding to the handwritten annotation of the enclosure line detected in step S910 is highlighted and displayed. Specifically, the text region is displayed more conspicuously by erasing the original handwritten annotation and changing the background color of the corresponding text region into a chromatic color.

For example, a text region 1507 illustrated in FIG. 15D is an example in which the handwritten annotation 1501 of the enclosure line illustrated in FIG. 15A is highlighted and displayed. A text region 1508 illustrated in FIG. 15E is an example in which the handwritten annotation 1502 of the enclosure line illustrated in FIG. 15B is highlighted and displayed. In the example illustrated in FIG. 15E, the text region corresponding to the handwritten annotation 1502 extends to a plurality of rows. Therefore, a region that the expositor desires to highlight is estimated to be the plurality of entire rows contained by the enclosure line. Accordingly, as in FIG. 15E, the entire rows of the text region including the annotation 1502 are highlighted and displayed.

Next, in step S1407, it is determined whether the region of the enclosure line is a photo region rectangular block (drawing region) or a graphic region rectangular block (drawing region). For example, an object 1503 on a page 401 illustrated in FIGS. 15C and 15F is a photo region rectangular block and the region of a handwritten annotation 1506 of the enclosure line is determined to be in the photo region rectangular block.

Specifically, when 80% or more of the region of the handwritten annotation of the enclosure line is included in the photo or graphic region rectangular block, the annotation of the enclosure line is determined to be in the photo or graphic region rectangular block. Here, the threshold value is a value which can be arbitrarily changed and is not limited to 80%. When the annotation of the enclosure line is determined to be in the photo or graphic region rectangular block (YES), the process proceeds to step S1408. Conversely, when the annotation of the enclosure line is determined not to be in the photo or graphic region rectangular block (NO), the process proceeds to step S1410.

Next, in step S1408, an object (drawing object) included in the photo or graphic region rectangular block is extracted. For example, an object 1505 which is a copy machine is extracted from the region of the annotation 1506 of the enclosure line on the page 401 illustrated in FIG. 15C. A method of extracting the object depends on pattern matching using a known feature amount.

In the embodiment, the object is extracted by selecting a region larger than the region of the handwritten annotation 1506 and performing pattern matching between the selected region and an image database stored in advance. Since an object extraction method using feature amounts is a known technology, further detailed description will be omitted. The object extraction method may be performed based on a luminance value histogram or an edge of an image. The present invention is not limited to the pattern matching of the feature amounts.

Next, in step S1409, the original handwritten annotation is erased and the region other than the region of the object extracted in step S1408 is grayed out and displayed. Specifically, the region of the object surrounded by the handwritten annotation 1506 is displayed more conspicuously by graying out and displaying the region other than the region of the object 1505, as illustrated in FIG. 15F.

In the embodiment, as described above, by using the attribute information regarding the image data of the region surrounded by the enclosure line in addition to the expression method according to the first embodiment, it is possible to change and display the expression of the partial region of the image in accordance with the proper effective expression for the intention of the expositor.

### Third Embodiment

In the first embodiment, the example in which the annotation processing unit 305 dynamically changes the expression of the partial region of the image according to the attribute of the object and the classification of the annotation has been described. In the second embodiment, the example in which the region of the handwritten annotation of the enclosure line is the text or graphic region rectangular block has been described. Accordingly, since the expression according to the intention of the expositor is possible, the proper effective display for presentation is possible.

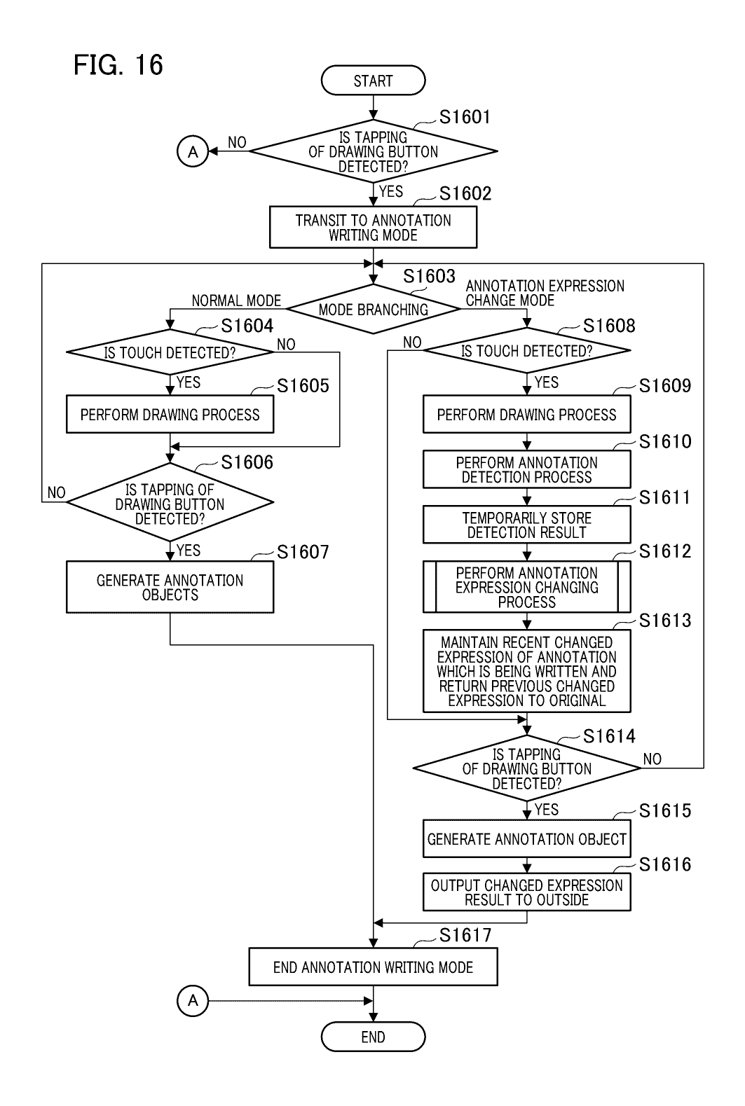

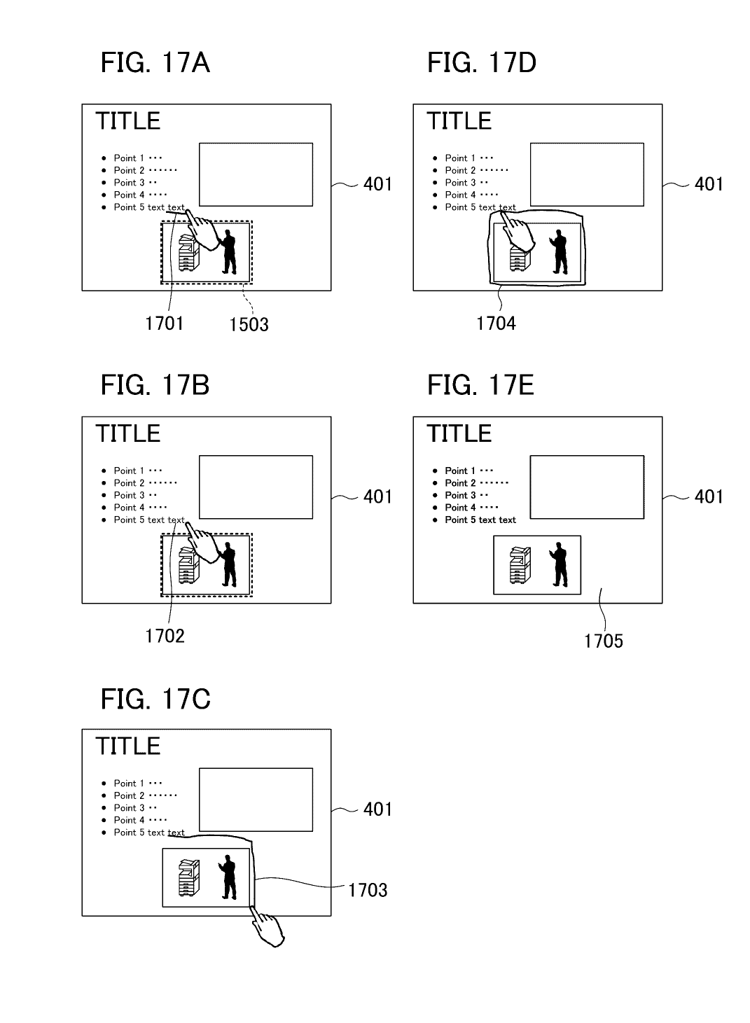

In the embodiment, an example in which an expression of a partial region of an image is changed in real time while an expositor writes an annotation will be described. Hereinafter, differences from the first and second embodiments will be mainly described with reference to FIGS. 16 and 17A to 17E. FIG. 16 is a flowchart for when an annotation according to the embodiment is written. FIGS. 17A to 17E illustrate an example in which a partial region in an image is changed and displayed in real time when the annotation is written during display of application image data according to the embodiment.

Steps S1601 to S1615 illustrated in FIG. 16 are executed and processed by the software module 300. Since steps S1601 to S1610 and S1617 are the same processes as steps S901 to S910 and S914 illustrated in FIG. 9, the detailed description will be omitted. First, in step S1611, a detection result of a handwritten annotation detected by the annotation detection unit 305 is temporarily stored.

Next, in step S1612, the annotation expression changing process illustrated in FIG. 11 or 14 described above is performed. The annotation expression changing process is performed according to the attribute information regarding the handwritten annotation. In the embodiment, the expression of the partial region of the image is changed in real time using the detection result immediately after the handwritten annotation is detected in step S1611.

For example, the expression changing process for a handwritten annotation of an underline illustrated in FIG. 17A is frequently performed based on the detection result of step S1611 even while the expositor writes the annotation, as in a partial region 1702 illustrated in FIG. 17B. It is assumed that the expression changing process according to the embodiment is performed only on the LCD 201 of the image display apparatus 100 used by the expositor and is not output to a screen viewed by an audience. This is because the result during the editing is configured not to be seen by the audience, but the same display as the display viewed by the expositor can also be output.

Next, in step S1613, the changed expression of the annotation based on the recent detection result of step S1611 is displayed and the previous changed expression is returned to the original. For example, an annotation 1703 illustrated in FIG. 17C is a handwritten annotation continuously written by the expositor without removing his or her finger after the expression change display of the partial region 1702 illustrated in FIG. 17B. However, at this time, the changed expression of the partial region 1702 returns to the original handwritten annotation.

That is, at the time point illustrated in FIG. 17C, the recent annotation detection result of step S1611 is not an underline, a cancellation line, or an enclosure line. Therefore, a normal handwritten annotation which is not changed and displayed is displayed. In the embodiment, it is assumed that the expositor inputs a handwritten annotation 1704 continuously up to the position of the finger in FIG. 17D after the position in FIG. 17C. At this time, display of the image display apparatus 100 before detection of tapping of the drawing button 402 in step S1614 is illustrated in FIG. 17E. This is because the annotation detection result of the handwritten annotation 1704 is an enclosure line of the object 1503. The region other than the object 1503 is grayed out and displayed.

Next, in step S1614, it is detected whether the drawing button 402 on the UI 204 is single-tapped. When the drawing button 402 is single-tapped (YES), the process proceeds to step S1615. Conversely, when the drawing button 402 is not single-tapped (NO), the process returns to step S1603. Next, in step S1615, the annotation object is generated by the annotation generation unit 308 as in step S912. In step S1615, annotation attribute information is generated based on the detection result temporarily stored in step S1611.

Next, in step S1616, the changed expression result of the decided handwritten annotation is output to the outside via the RGB output controller 214. In the embodiment, a display result illustrated in FIG. 17E is output.

In the embodiment, as described above, the change in the expression of the annotation is reflected on the image display apparatus 100 in real time during the writing of the handwritten annotation. Therefore, the expositor can write the annotation while confirming the reflected result. Accordingly, the expositor can write the annotation more simply according to his or her intention.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-078384, filed Apr. 7, 2015, which is hereby incorporated by reference wherein in its entirety.

What is claimed is:

1. An information processing apparatus comprising:
a display unit configured to display an image including a plurality of objects on a screen;
a generation unit configured to generate block information indicating information of blocks obtained by dividing the object for each attribute;
an input unit configured to recognize handwriting of an annotation written on the image by hand;
a detection unit configured to detect classification of the annotation based on the handwriting; and
a display changing unit configured to estimate a partial region to focus based on a relation between the block information and the handwriting and dynamically change and display an expression of the partial region according to the classification of the annotation.

2. The information processing apparatus according to claim 1,
wherein, when the detection unit detects that the annotation is an underline with regards to a text region of the partial region, the display changing unit emphasizes and displays the text region.

3. The information processing apparatus according to claim 1,
wherein, when the detection unit detects that the annotation is a cancellation line with regards to a text region of the partial region, the display changing unit displays the text region inconspicuously.

4. The information processing apparatus according to claim 1,
wherein, when the detection unit detects that the annotation is an enclosure line with regards to the partial region, the display changing unit emphasizes and displays the partial region.

5. The information processing apparatus according to claim 4,
wherein, when an area of a region surrounded by the enclosure line occupies an area equal to or greater than a predetermined area of the partial region, the display changing unit emphasizes and displays the entire partial region.

6. The information processing apparatus according to claim 4,
wherein, when an area of a region surrounded by the enclosure line occupies an area less than a predetermined area of the partial region, the display changing unit emphasizes and displays only the region surrounded by the enclosure line.

7. The information processing apparatus according to claim 4,
wherein, when a region surrounded by the enclosure line is in a text region of the partial region, the display changing unit emphasizes and displays the text region surrounded by the enclosure line.

8. The information processing apparatus according to claim 4,
wherein, when a region surrounded by the enclosure line is in a drawing region of the partial region, the display changing unit extracts a drawing object surrounded by the enclosure line and emphasizes and displays the drawing object.

9. The information processing apparatus according to claim 1,
wherein, immediately after the detection unit detects the classification of the annotation, the display changing unit displays an expression changed according to the classification on the screen and outputs the expression for which the change is confirmed to outside.

10. A method for controlling an information processing apparatus, comprising:
displaying an image including a plurality of objects on a screen;
generating block information indicating information of blocks obtained by dividing the object for each attribute;
recognizing handwriting of an annotation written on the image by hand;
detecting classification of the annotation based on the handwriting; and
estimating a partial region to focus based on a relation between the block information and the handwriting and dynamically changing and displaying an expression of the partial region according to the classification of the annotation.

11. A non-transitory storage medium on which is stored a computer program for making a computer function as respective units of an information processing apparatus, the information processing apparatus comprising:
a display unit configured to display an image including a plurality of objects on a screen;
a generation unit configured to generate block information indicating information of blocks obtained by dividing the object for each attribute;
an input unit configured to recognize handwriting of an annotation written on the image by hand;
a detection unit configured to detect classification of the annotation based on the handwriting; and
a display changing unit configured to estimate a partial region to focus based on a relation between the block information and the handwriting and dynamically change and display an expression of the partial region according to the classification of the annotation.
